(19) United States
(12) Patent Application Publication
(10) Pub. No.: US 2026/0008629 A1
(43) Pub. Date: Jan. 8, 2026

(54) CONVEYOR BELT WIPER SYSTEM AND METHODS RELATING TO THE SAME

(71) Applicant: Mayfran International Inc., Cleveland, OH (US)

(72) Inventors: Michael Charles Gervasi, Mayfield Village, OH (US); John Edward Eads, Mayfield Village, OH (US); Nebojsa Petrovic, Mayfield Village, OH (US); Christopher Martin Peavey, Mayfield Village, OH (US)

(21) Appl. No.: 19/259,959

(22) Filed: Jul. 3, 2025

Related U.S. Application Data
(60) Provisional application No. 63/667,194, filed on Jul. 3, 2024.

(51) Int. Cl. B65G 45/24; B65G 15/42; B65G 43/08; B65G 45/16; B65G 45/18; B65G 45/26

(52) U.S. Cl. CPC B65G 45/24; B65G 43/08; B65G 45/16; B65G 45/18; B65G 45/26; B65G 15/42; B65G 2203/0266

(57) ABSTRACT

A conveyor belt system that includes a wiper system that removes and/or dislodges material from a conveyor belt that remains on a top surface of said conveyor belt while said conveyor belt moves on a bottom track.

### REFERENCED APPLICATION

This patent application claims the benefit of U.S. Provisional Patent Application Serial Nos. 63/667,194 filed on Jul. 3, 2024, the disclosure of which are hereby incorporated fully by reference herein in its entirety and is made part of the present U.S. utility patent application for all purposes.

### FIELD OF DISCLOSURE

The present disclosure relates generally to conveyor systems, and more specifically to a conveyor belt wiper system for removing certain types of material (e.g., pourable conveying material, small particles, material that has temporality adhered to the conveyor belt, etc.) from the conveyor belt.

### BACKGROUND OF DISCLOSURE

Conveyors can enable removal of pourable conveying material (e.g., bulk material) that accumulates when machining materials and/or stamping materials, such as metallic materials. Metallic materials such as steel, aluminum, brass, and others can be in various shapes and size forms, ranging from small chips (about <1 inch in diameter, in one non-limiting example) to large chips (over about 48 inch+ in diameter, in another non-limiting example). When processes utilize a liquid such as water-based coolant, oil-based coolant, oil, and other liquids, residual liquids can coat such materials/chips as they fall onto the conveyor belt. Such liquids can cause a suction and/or adherence type of reaction resulting in some materials/chips to stick to the conveyor belt, thereby preventing disengagement from the conveyor belt as the belt moves around the end of the run to the discharge area.

As the materials/chips build and stick to the belt, there are certain points where the materials/chips lose grip with the belt and can fall off the conveyor in unfavorable spots (along and/or in the frame, in the tail end of the conveyor [as the belt run travels from the bottom track to the top track], on pit floors, etc.). As such, material/chip buildup, especially when coated in such liquids, can be damaging to the surrounding area, causing for: (i) safety concerns in and/or around access areas of the conveyor; and (ii) arduous maintenance processes to clean surrounding areas. Keeping surrounding areas clean in addition to limiting safety concerns is a major problem in most commercial and industrial applications. Not only is it very costly in labor to clean and maintain surrounding areas, but the down-time of processes involving the conveyor often means a loss in profit for most operations. There is an industry need to limit material buildup in and around conveyor areas while still maintaining safety compliances and good practices.

Accordingly, there is an ongoing need for systems, methods, and assemblies for limiting material/chip buildup in and around conveyor areas, while maintaining safety compliance and good practices.

### SUMMARY OF DISCLOSURE

The present disclosure relates generally to a conveyor belt wiper system for removing conveying material from the conveyor belt, thereby limiting material buildup in and around conveyor areas and maintaining safety compliance and good practices. In one non-limiting embodiment, there is provided a wiper system that runs along at least a portion of the conveyor belt and is configured to disengage materials that inadvertently adhered to the conveyor belt and optionally direct the disengaged/remove material down a chute and into an optional container/bin.

In another and/or alternative aspect of the present disclosure, there is provided a conveyor that includes an endless belt and a belt return device intended to carry or transport materials a set distance; and top and bottom tracks that the continuous belt runs on; and wherein there is an intermediate space between the upper conveyor belt run and lower conveyor belt run that is created by the spacing between the top and bottom tracks; and wherein the conveyor belt travels in a direction determined by the motor/drive that is connected or interconnected to the conveyor belt; and wherein as the conveyor belt reaches the end of the run, the conveyor belt wraps around from the top track to the bottom track and travels in the opposite direction in a continuous motion; and wherein material that is conveyed on the top portion of the conveyor belt is transferred to the end of the run, and due to weight and gravity, the material falls off the designated discharge point as the conveyor belt wraps around the end of the run and changes direction (e.g., changes direction in the opposite way, etc.); and wherein a wiper system engages and/or is positioned closely adjacent to a portion of the conveyor belt (e.g., positioned on a region of the bottom run of the conveyor belt, etc.) to remove material that remain on the top surface of the conveyor belt after the conveyor belt has past the end run of the conveyor belt.

In another and/or alternative non-limiting aspect of the present disclosure, there is provided a wiper system and an optional chute; and wherein the chute is configured to receive material that is dislodged from the conveyor belt by the wiper system.

In another and/or alternative non-limiting aspect of the present disclosure, the wiper system optionally includes one or more wipers. The one or more wipers are configured to engage with material on the top surface of the conveyor belt and facilitate in dislodging such material from the top surface of the conveyor belt as the conveyor belt pass the one or more wipers. In another non-limiting embodiment, the one or more wipers of the wiper system can optionally be positioned on a shaft or other support structure. In another non-limiting embodiment, the shaft or other support structure for the one or more wipers can optionally extend along a portion or all of a width or length of the conveyor (e.g., 20-100% of the width of the conveyor and all values and ranges therebetween) and/or optionally extend along a portion or all of a width or length of one or more openings (e.g., top opening, side opening, etc.) of the chute (e.g., 20-100% of the width or length of one or more openings and all values and ranges therebetween).

In another and/or alternative non-limiting aspect of the present disclosure, the wiper system optionally includes one or more brushes/scrapers. The one or more brushes/scrapers are configured to engage with material on the top surface of the conveyor belt and facilitate in dislodging such material from the top surface of the conveyor belt as the conveyor belt passes the one or more brushes/scrapers. In another non-limiting embodiment, the one or more brushes/scrapers of the wiper system can optionally be positioned on a shaft or other support structure. In another non-limiting embodiment, the shaft or other support structure for the one or more brushes/scrapers can optionally extend along a portion or all of a width or length of the conveyor (e.g., 20-100% of the width of the conveyor and all values and ranges therebetween) and/or optionally extend along a portion or all of a width or length of one or more openings (e.g., top opening, side opening, etc.) of the chute (e.g., 20-100% of the width or length of one or more openings and all values and ranges therebetween).

In another and/or alternative non-limiting aspect of the present disclosure, the wiper system optionally includes one or more counterweights and/or one or more spring-loaded systems that are configured to cause the one or more wipers, and/or brushes/scrapers on the wiper system to engage with material on the top surface of the conveyor belt as the conveyor belt pass the one or more wipers, and/or brushes/scrapers.

In another and/or alternative non-limiting aspect of the present disclosure, the wiper system optionally includes one or more adjustable plate mechanisms that are configured to adjust the one or more wipers and/or brushes/scrapers towards and/or away from the conveyor belt so as to (i) reduce wear on the one or more wipers and/or brushes/scrapers; (ii) obtain the desired spacing from or engagement with the conveyor belt by the one or more wiper and/or brushes/scrapers; and/or (iii) provide desired performance results of dislodging material from the top surface of the conveyor belt as the conveyor belt pass the one or more wiper and/or brushes/scrapers.

In another and/or alternative non-limiting aspect of the present disclosure, the wiper system optionally includes one or more belt-thumpers and/or vibration arrangements that are configured to provide a “knocking” and/or similar vibration to the conveyor belt to assist in jarring/disengaging the material from the conveyor belt as the conveyor belt passes the wiper system.

In another and/or alternative non-limiting aspect of the present disclosure, the wiper system optionally includes one or more anti-jamming assemblies that are configured to a) partially or fully clean one or more belt cleats as the conveyor belt pass the wiper system, and/or b) minimize or reduce the brush/cleat contact with the one or more wipers and/or brushes/scrapers so as to reduce wear on the one or more wipers and/or brushes/scrapers as the conveyor belt pass the wiper system.

One non-limiting object of the present disclosure is to provide a conveyor belt wiper system that is configured to facilitate in the removal materials from the conveyor belt.

In another and/or alternative non-limiting object of the present disclosure is to provide a conveyor belt wiper system for removing/dislodging conveying material from the conveyor belt, thereby limiting/eliminating material buildup in and around conveyor areas (e.g., top surface of the conveyor belt, belt cleats, etc.) and/or maintaining safety compliance and/or good practices.

In another and/or alternative non-limiting object of the present disclosure is to provide a conveyor belt wiper system that includes a wiper system that runs along at least a portion of the conveyor belt and is configured to disengage/remove materials that have adhered to and/or otherwise remain on the conveyor belt and/or belt cleats; and wherein the wiper system optionally directs the disengaged material to/down an optional chute and/or into an optional container.

In another and/or alternative non-limiting object of the present disclosure is to provide a conveyor belt wiper system that is used in conjunction with an optional chute; and wherein the chute is configured to receive material that are dislodged/removed from the conveyor belt and/or belt cleats by the wiper system.

In another and/or alternative non-limiting object of the present disclosure is to provide a conveyor belt wiper system that that includes one or more wipers and/or brushes/scrapers that are configured to engage with material on the top surface of the conveyor belt and/or belt cleats and facilitate in dislodging/removing such material from the top surface of the conveyor belt and/or belt cleats as the conveyor belt pass the one or more wipers and/or brushes/scrapers.

In another and/or alternative non-limiting object of the present disclosure is to provide a conveyor belt wiper system that optionally includes a wiper positioning system that is configured to cause the one or more wiper and/or brushes/scrapers on the wiper system to partially or fully engage with material on the top surface of the conveyor belt and/or belt cleats as the conveyor belt and/or belt cleats pass the one or more wipers and/or brushes/scrapers.

In another and/or alternative non-limiting object of the present disclosure is to provide a conveyor belt wiper system that optionally includes an adjustment system that are configured to adjust the one or more wipers and/or brushes/scrapers towards and/or away from the conveyor belt and/or belt cleats.

In another and/or alternative non-limiting object of the present disclosure is to provide a conveyor belt wiper system that optionally includes or is optionally used with one or more belt-thumpers and/or vibration arrangements that are configured to provide a “knocking” and/or similar vibration to the conveyor belt to assist in jarring/disengaging the material from the conveyor belt and/or belt cleats as the conveyor belt passes the wiper system.

In another and/or alternative non-limiting object of the present disclosure is to provide a conveyor belt wiper system that optionally includes one or more anti-jamming assemblies that are configured to a) partially or fully clean one or more belt cleats as the conveyor belt passes the wiper system, and/or b) minimize or reduce the brush/cleat contact with the one or more wipers and/or brushes/scrapers so as to reduce wear on the one or more wipers and/or brushes/scrapers as the conveyor belt passes the wiper system.

These and other objects and advantages will become apparent to those skilled in the art upon reading and following the description taken together with the accompanying drawings.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIGS. 1A and 1B depict a non-limiting exemplary wiper system in relation to an exemplary conveyor having a continuous belt; and wherein FIG. 1A depicts the wiper system disposed in a chute having a protective guard; and wherein FIG. 1B is an enlarged view of the wiper system of FIG. 1A in the chute without the protective guard;

FIG. 2 is an enlarged non-limiting depiction of the wiper system of FIGS. 1A and 1B contacting a portion of the continuous belt of the exemplary conveyor;

FIG. 3 is an isometric view of the wiper system of FIGS. 1A and 1B;

FIG. 4 is a forward-facing view of the wiper system of FIG. 3 which is installed in the chute;

FIG. 5 is a side view of the wiper system of FIG. 3;

FIG. 6 depict another non-limiting, exemplary wiper system in relation to an exemplary conveyor having a continuous belt, wherein the exemplary wiper system is disposed within a chute;

FIG. 7 is a forward-facing view of the wiper system of FIG. 6;

FIG. 8 is a side view of a non-limiting, exemplary solid (anti-jamming) scraper assembly; and

FIG. 8A is an enlarged portion of the solid (anti-jamming) scraper assembly of FIG. 8 illustrating a solid scraper and/or brush attached to a plate holder.

### DESCRIPTION OF NON-LIMITING EMBODIMENTS

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function. The singular forms “a,” “an,” and “the” include plural referents unless the context clearly dictates otherwise.

The singular forms “a,” “an,” and “the” include plural referents unless the context clearly dictates otherwise.

As used in the specification and in the claims, the term “comprising” may include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

Referring now to the drawings, the present disclosure provides a belt wiper assembly system, assembly, and method for dislodging/removing conveying material from a conveyor belt and/or belt cleats and/or other structures on the top surface of the conveyor belt. Conveyors generally include: (i) a continuous, endless conveyor belt intended to carry or transport the conveying material to a predetermined distance/location; (ii) a belt return device; (iii) a top and bottom track, separated by an intermediate space, on which the continuous conveyor belt runs (i.e., a top run and a bottom run); and (iv) a motor or drive that moves the continuous conveyor belt in a predetermined direction. As can be appreciated, the conveyor belt can optionally include one or more blet cleats and/or other structures used to facilitate in the movement of the conveyor belt and/or to facilitate in the movement of materials on the conveyor belt. As the conveyor's belt reaches the end of the run, it wraps around from the top track to the bottom track and travels in an opposite direction and in a continuous motion. The material that is conveyed on the top track is transferred to the end of the run and, due to weight and gravity, the material falls off a designated discharge point as the conveyor belt wraps and moves in the opposite direction. The present disclosure is directed to a wiper system that advantageously disengages/dislodges some or all material that inadvertently remains on/adhered to the conveyor belt/belt cleats and/or other structures on the conveyor belt running on the bottom track, thereby limiting/preventing material buildup in and around conveyor areas, and/or maintaining safety compliance and/or good operational practices.

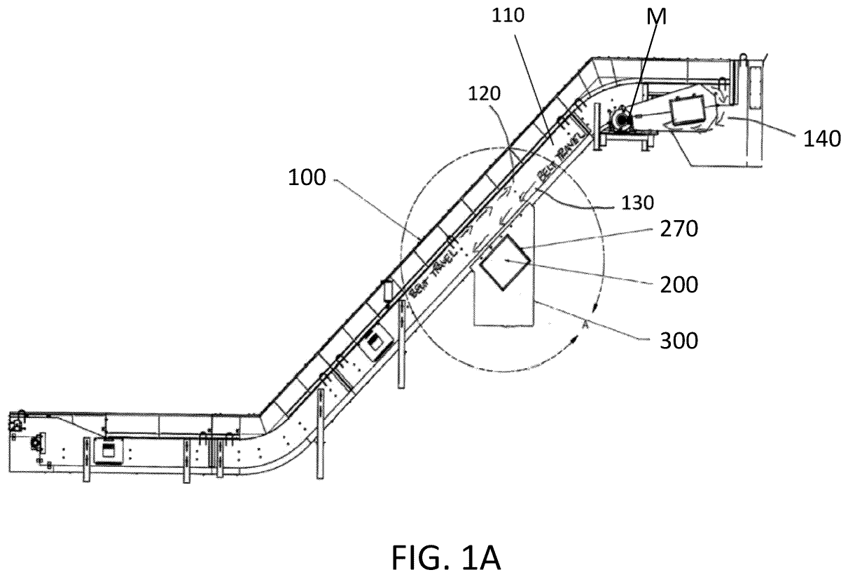

With reference to FIGS. 1A-1B, a conveyor 100 is provided having an endless conveyor belt 110 that is driven by a motor M. The endless conveyor belt 110 travels along a top track 120 and a bottom track 130 of the conveyor 100. In the present non-limiting embodiment, the endless belt 110 travels in a first direction (from left to right) along the top track 120. At the end of the run, the endless conveyor belt 110 wraps around a head portion 140 (e.g., belt return device, etc.) of the conveyor 100, and the endless conveyor belt 110 travels in an opposite direction on the bottom track 130 (from right to left) to that of the first direction. It is to be appreciated that material is placed/deposited on the top surface of the conveyor belt 110 and conveyed by the conveyor belt as the conveyor belt travels on the top track 120. The type of devices and the manner in which the material is placed on the top surface of the conveyor belt 110 are well known in the art, thus will not be described herein. Also, the types of materials that can be conveyed by the conveyor belt 110 are well known in the art, thus will not be described herein.

The material on the top surface of the conveyor belt 110 is discharged from the conveyor belt at and/or near the head portion 140. It is to be appreciated that the motor can drive the endless conveyor belt 110 from left to right along the top track 120 and correspondingly cause the endless conveyor belt 110 to travel from right to left along the bottom track 130. Generally, most of the material on the top surface of the conveyor belt 110 falls off of the conveyor belt 110 as the conveyor belt 110 wraps around a head portion 140 of the conveyor 100. The material that falls off or is otherwise discharged from the conveyor belt 110 can fall into a collection bin, fall onto another conveyor belt, fall into a storage facility or area, landfill, etc., fall into a railcar, truck, storage container, etc., or fall into some other receptacle or location that is well known in the art.

Still referring to FIGS. 1A-1B, there is provided is a wiper system 200 that is configured to disengage some or all material that still remains on and/or adhered to the top surface of the endless conveyor belt 110 as the conveyor belt travels along the bottom track 130 as a result of not being discharged at and/or near the head portion 140. In one non-limiting embodiment, when the wiper system 200 disengages/dislodges some or all of the material from the top surface of the conveyor belt 110 as the conveyor belt 110 moves along the bottom track 130, the disengaged/dislodged material falls from the endless conveyor belt 110. In one non-limiting configuration, a chute or catch 300 can optionally be positioned at, near, under, etc. the wiper system 200 to catch some or all of the disengaged/dislodged material that falls from the endless conveyor belt 110. As will be discussed in greater detail below, the wiper system 200 can optionally include one or more counterweights 255a configured to apply a force on one or more portions of the wiper system 200 to cause the one or more wipers and/or brushes to engage the endless belt 110. The one or more counterweights 255a can be optionally adjustable to adjust the force of the one or more wipers and/or brushes to the top surface of the conveyor belt 110, and/or belt cleats, and/or other structures on the conveyor belt 110. In another non-limiting embodiment, the chute 300 can optionally be configured to partially or fully house the wiper system 200. It can be appreciated that in some non-limiting embodiments, the chute 300 can a) optionally be coupled to the conveyor 100, b) optionally coupled to the wiper system 200, c) optionally be spaced from the wiper system 200 and optionally be positioned beneath the wiper system 200 or be optionally positioned partially or fully about the wiper system, or d) optionally be spaced from the conveyor 100 and the wiper system 200 and optionally positioned beneath the wiper system 200 or be optionally positioned partially or fully about the wiper system. It can also be appreciated that a container or receptacle (e.g., dump truck or other vehicle, railcar, shipping container, etc.), another conveyor, etc., can be partially or fully positioned in the chute or be positioned below the chute to capture or otherwise contain and/or transport the material that falls into the chute. As can also be appreciated, the container or receptacle, when used, can be removable for convenient disposal of material in the container or receptacle, and thereafter, the container or receptacle can optionally be repositioned relative to the chute to again receive material that falls into the chute.

Still referring to FIGS. 1A-1B, in some non-limiting embodiments, the wiper system 200 is partially or substantially surrounded by a protective guard 270. In certain non-limiting embodiments, one or more portions or all of the protective guard 270 can be removed to expose components of the wiper system 200 (see FIG. 1B where protective guard 270 has been removed). The protective guard 270, when used, can be formed of one or more pieces, and the material used to form the protective guard is generally a durable material (e.g., metal, durable plastic, composite material, etc.).

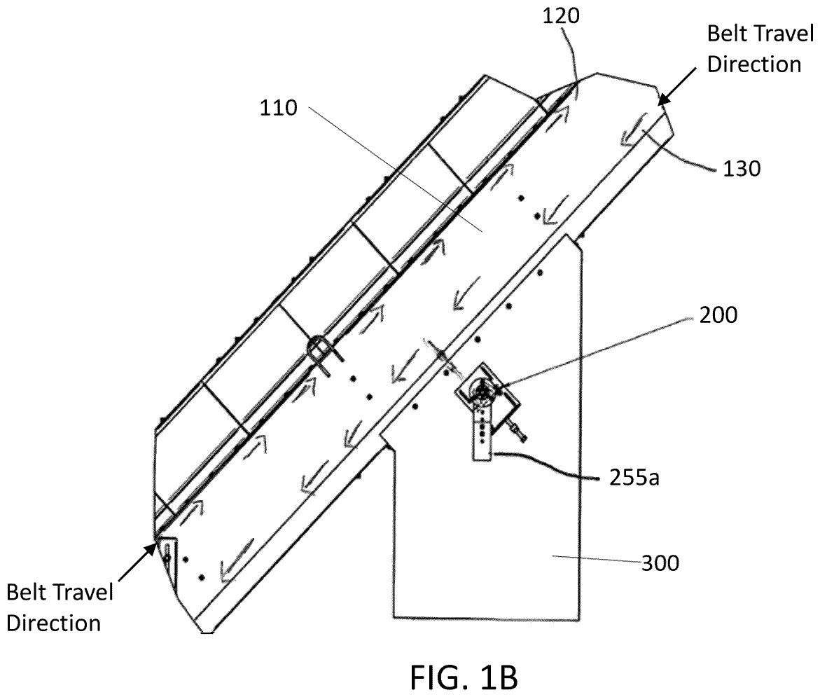

FIG. 2 provides a non-limiting depiction of the wiper system 200 contacting a portion of the top surface of the endless belt 110 as the conveyor belt travels along the bottom track 130 of the conveyor 100. With reference to FIG. 2, the endless belt 110 may optionally include one or more belt cleats 150. The one or more belt cleats 150 may aid the material in traveling through various levels of incline/decline along the conveyor 100 when the convey 100 optionally includes an incline and/or decline region. In some non-limiting embodiments, the one or more belt cleats 150 may be variably sized, having, for example, a height that extends upwardly from a top surface of the conveyor belt 110 of at least 0.01 inches (e.g., 0.01-20 inches, and all values and ranges therebetween) and/or are spaced apart at least 0.1 inch (e.g., 0.1-75+ inches and all values and ranges therebetween) increments along a portion of the entire length of the conveyor belt 110. The shape and size of the one or more optional belt cleats 150 is non-limiting. As can be appreciated, the conveyor belt 110 can include other or additional structures to facilitate in the movement of material on the conveyor belt 110 and/or the movement of the conveyor belt on the conveyor 100.

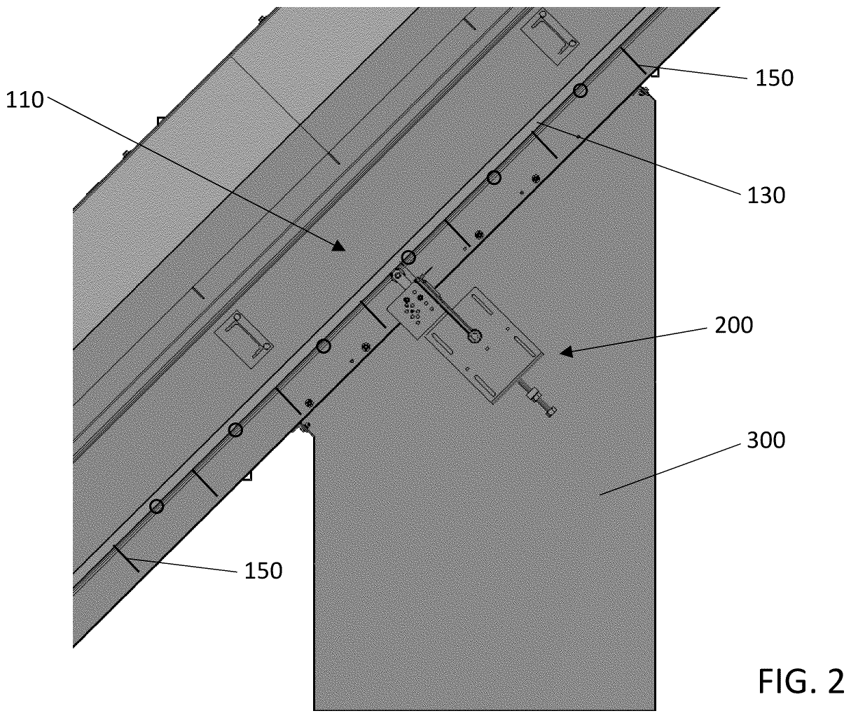

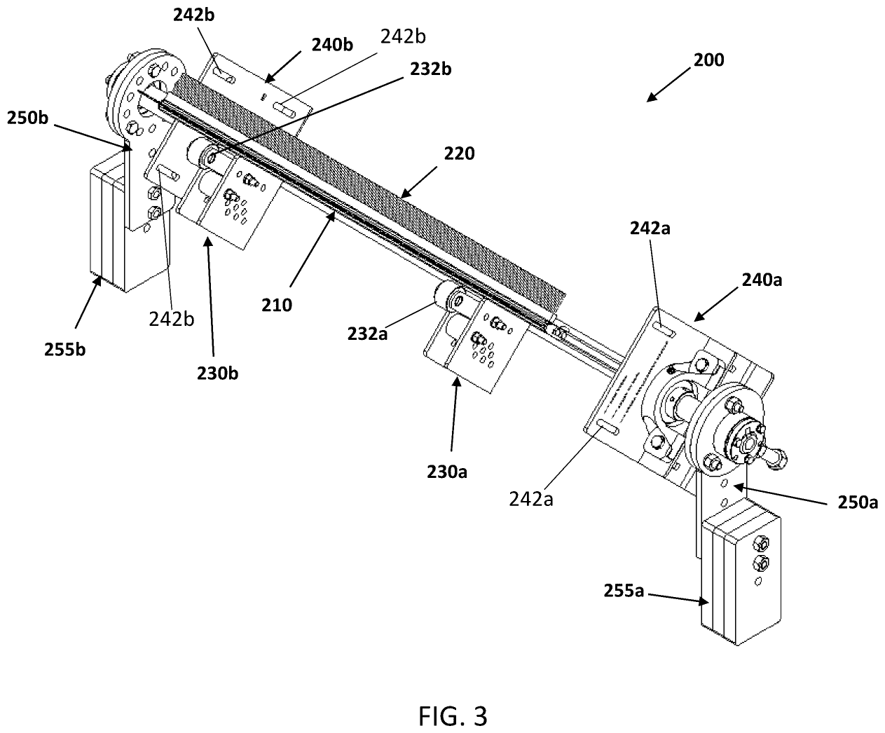

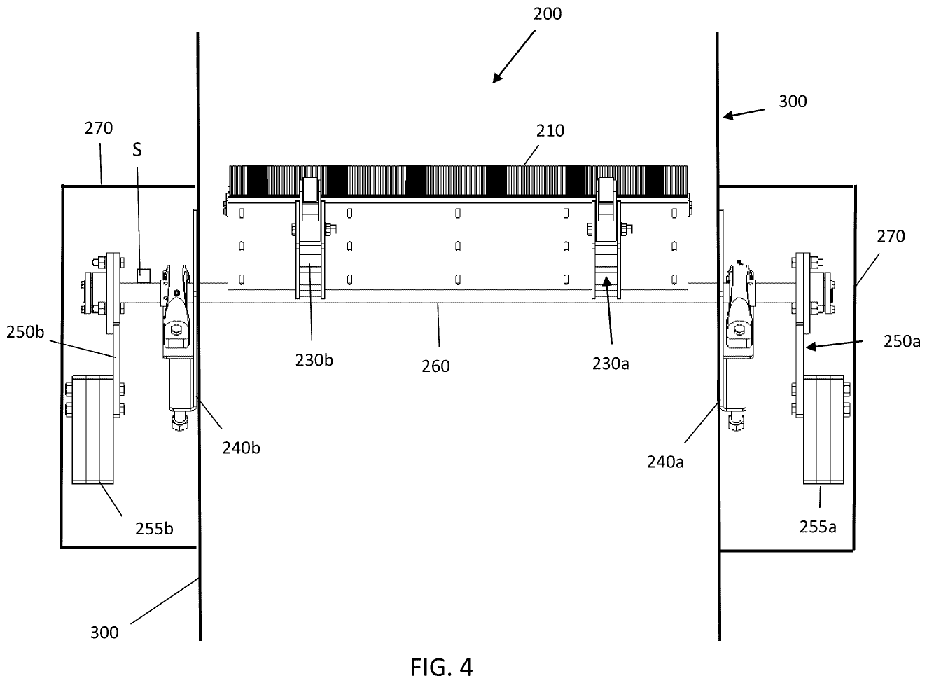

FIG. 3 is an isometric view of a non-limiting wiper system 200. FIG. 4 is a forward-facing view of the non-limiting wiper system 200 configured within the chute 300. FIG. 5 is a side view of the non-limiting wiper system 200.

With reference to FIGS. 1-5, the wiper system 200 includes: (i) a first wiper, brush and/or scraper 210 that is configured to remove/dislodge material from the top surface of endless conveyor belt 110 as it travels along the bottom track 130 of the conveyor 100; (ii) an optional second wiper, brush and/or scraper 220 that is configured to clean the one or more belt cleats 150 that may or may not exist on the conveyor belt; (iii) one or more optional thumpers 230a, 230b; (iv) one or more optional adjustable plate mechanisms 240a, 240b; and (v) one or more optional mounting brackets 250a, 250b that can each optionally have one or more counterweights 255a, 255b, respectively. In the present non-limiting embodiment, a shaft 260 supports one or more of the first wiper, brush and/or scraper 210, the optional second wiper, brush and/or scraper 220, the optional one or more thumpers 230a, 230b, the optional one or more adjustable plate mechanisms 240a, 240b, and/or the one or more optional mounting brackets 250a, 250b. The shaft 260 can optionally runs along a portion of all of the inside length of the chute 300. The shaft can optionally be connected to the chute 300, a portion of the wiper system and/or some other portion of the conveyor system.

The shape and size and configuration of the first wiper, brush and/or scraper 210 is non-limiting. In one non-limiting embodiment, the first wiper, brush and/or scraper 210 is partially or fully formed of plastic, rubber, metal, fiber material or composite material. In another non-limiting embodiment, the first wiper, brush and/or scraper 210 is formed of one piece. In another non-limiting embodiment, the first wiper, brush and/or scraper 210 is formed of or includes a plurality of bristles. In another non-limiting embodiment, the first wiper, brush and/or scraper 210 have the same or a different configuration from the optional second wiper, brush and/or scraper 220 when used; however, this is not required. In another non-limiting embodiment, the first wiper, brush and/or scraper 210 have the same height or a shorter height or a greater height than the optional second wiper, brush and/or scraper 220 when used. In another non-limiting embodiment, the optional second wiper, brush and/or scraper 220, when used, is formed of or includes a plurality of bristles. In one non-limiting embodiment, the optional second wiper, brush and/or scraper 220 is partially or fully formed of plastic, rubber, metal, fiber material, or composite material. In another non-limiting embodiment, the first wiper, brush and/or scraper 210 is spaced from the optional second wiper, brush and/or scraper 220 when used.

Still referring to FIGS. 1-5, as the endless conveyor belt 110 moves from right to left on the bottom track 130 of the conveyor 100, the first wiper, brush and/or scraper 210 is positioned closely to or engages the top surface of the conveyor belt 110 to remove/dislodge some or all material from the top surface of the conveyor belt as the conveyor belt moves past the wiper system 200. The optional second wiper, brush and/or scraper 220, when used, can optionally remove/dislodge some or all material on or about the one or more optional belt cleats 150 while the first wiper, brush and/or scraper 210 removes some or all material from the top surface of the conveyor belt. As can be appreciated, the first wiper, brush and/or scraper 210 can also be used to remove/dislodge material from the one or more optional belt cleats 150. Likewise, it can be appreciated that the optional second wiper, brush and/or scraper 220, when used, can optionally remove/dislodge some or all material on the top surface of the conveyor belt 110. In one non-limiting embodiment, the spacing of the end of the optional second wiper, brush and/or scraper 220 from the top surface of the conveyor belt 110 can be the same or greater than the spacing of the end of the first wiper, brush and/or scraper 210 from the top surface of the conveyor belt 110.

The thumpers 230a, 230b, when used, are configured to “knock” and/or vibrate the endless conveyor belt 110 and facilitate in the partial or full removal/dislodgement of material on the top surface of the conveyor belt that the first wiper, brush and/or scraper 210 misses, cannot contact, and/or otherwise did not remove/dislodge. As can be appreciated, the thumpers, when used, can partially or fully remove material on the top surface of the conveyor belt prior to, after, and/or as the first wiper, brush and/or scraper 210 partially or fully removes/dislodges material on the top surface of the conveyor belt 110. The thumpers 230a, 230b can each optionally include one or more rollers 232a, 232b. The one or more rollers 232a, 232b allow the conveyor belt 110 to freely move as the thumpers 230a, 230b contact the conveyor belt 110. The one or more rollers 232a, 232b can be configured to roll on a top surface of the conveyor belt. The one or more rollers 232a, 232b can generally be spaced such that there is no contact between the one or more rollers 232a, 232b and any optional belt cleats 150 as the conveyor belt 110 moves past the optional thumpers 230a, 230b. The thumpers 230a, 230b can be optionally moved mechanically or by a motor or some other movement mechanism.

As the first wiper, brush and/or scraper 210 and/or the second wiper, brush and/or scraper 220 wear over time (e.g. bristles of the brushes become worn and flaccid over time/use, portions of the scrapers become indented/worn, etc.), the adjustable plate mechanisms 240a, 240b can be adjusted via apertures 242a, 242b to move the first and/or second wiper, brushes or scrapers 210, 220 towards or away from the endless belt 110. It is to be appreciated that the adjustable plate mechanisms 240a, 240b can also be adjusted to maximize the brushes/scrapers engagement with the conveyor belt 110 and provide a desired performance result. As can be appreciated, the worn first wiper, brush and/or scraper 210 and/or second wiper, brush and/or scraper 220 can be replaced as required.

Still referring to FIGS. 1-5, when the conveyor belt optionally includes one or more belt cleats, as the one or more belt cleats 150 pass over the wiper system 200, the one or more counterweights 255a, 255b allow the shaft 260 to temporarily rotate/slide or otherwise move so as to temporarily disengage the first wiper, brush and/or scraper 210 from interaction with the conveyor belt 110 and allow the one or more belt cleats 150 to pass by first wiper, brush and/or scraper 210 of the wiper system 200. In some non-limiting embodiments, the second wiper, brush and/or scraper 220 continue to clean the one or more belt cleats 150 as the first wiper, brush and/or scraper 210 disengages or move away from the conveyor belt 110. When the one or more belt cleats 150 clear the wiper system 200, the one or more counterweights 255a, 255b cause the first wiper, brush and/or scraper 210 to move back into engagement or near engagement with the conveyor belt 110. The weight of the one or more counterweights 255a, 255b can be selected to minimize the time of disengagement between the first wiper, brush and/or scraper 210 and the belt 110 when a belt cleat 150 pass by the wiper system 200. The weight of the one or more counterweights 255a, 255b can also or alternatively be selected to control the amount of force of engagement of the first wiper, brush and/or scraper 210 with the top surface of the conveyor belt 110 as the conveyor belt 110 passes the first wiper, brush and/or scraper 210.

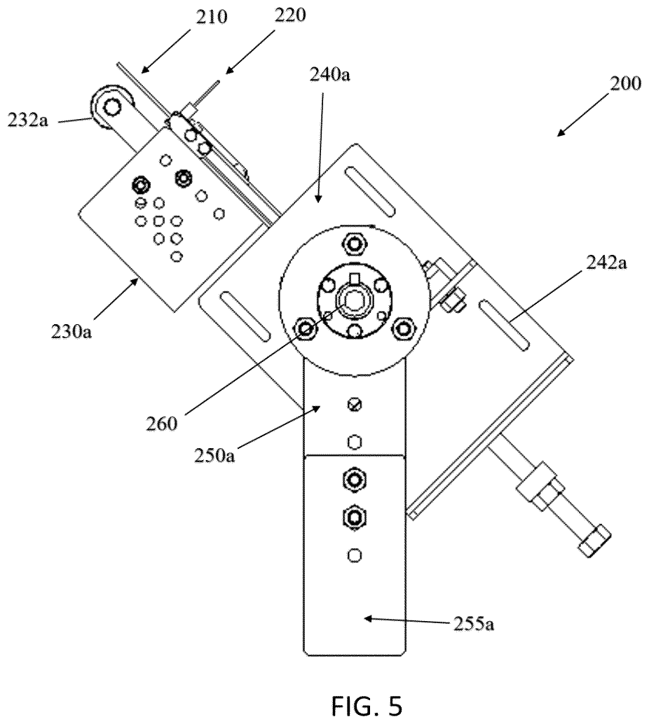

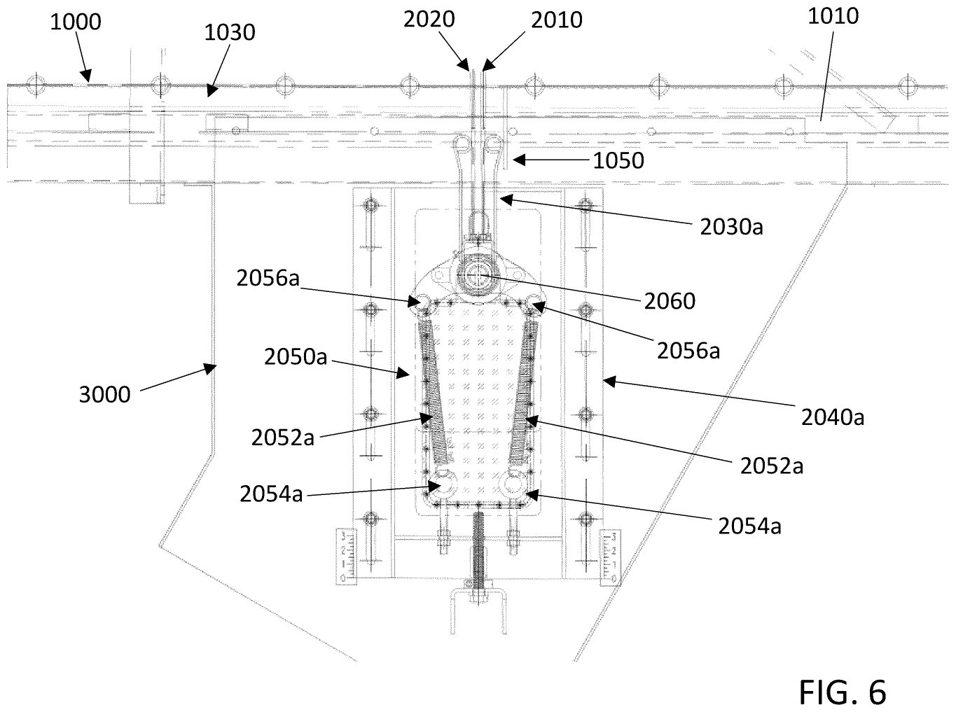

FIG. 6 depict another non-limiting, exemplary wiper system 2000. FIG. 7 is a forward-facing view of the wiper system 2000 of FIG. 6.

With reference to FIGS. 6-7, the wiper system 2000 is configured for use with conveyors similar to that of conveyor 100 and chutes similar to that of chute 300 as shown in FIGS. 1-5. For example, FIG. 6 illustrates a portion of a conveyor 1000 having an endless conveyor belt 1010 driven by a motor, and wherein the endless belt 1010 is traveling along a bottom track 1030 of the conveyor 1000 from right to left. As with the conveyor 100 of FIGS. 1-5, the conveyor 1000 in FIG. 6 optionally includes one or more belt cleats 1050. In one non-limiting embodiment, when the wiper system 2000 disengages/dislodges some or all of the material from the top surface of the conveyor belt 1010 as it travels on the bottom track 1030, the material falls from the endless conveyor belt 1010 into a chute or catch 3000. In one non-limiting embodiment, the chute 3000 is configured to partially or fully house the wiper system 2000. It is to be appreciated that in some non-limiting embodiments, the chute 3000 can a) optionally be coupled to the conveyor 1000, b) optionally coupled to the wiper system 2000, c) optionally be spaced from the wiper system 2000 and optionally be positioned beneath the wiper system 2000 or be optionally positioned partially or fully about the wiper system, or d) optionally be spaced from the conveyor 1000 and the wiper system 2000 and optionally positioned beneath the wiper system 2000 or be optionally positioned partially or fully about the wiper system. It can also be appreciated that a container or receptacle (e.g., dump truck or other vehicle, railcar, shipping container, etc.), another conveyor, etc., can be partially or fully positioned in the chute or be positioned below the chute to capture or otherwise contain and/or transport the material that falls into the chute. As can also be appreciated, the container or receptacle, when used, can be removable for convenient disposal of material in the container or receptacle, and thereafter, the container or receptacle can optionally be repositioned relative to the chute to again receive material that falls into the chute.

Still referring to FIGS. 6-7, in some non-limiting embodiments, the wiper system 2000 is partially or substantially surrounded by a protective guard 2070. In certain non-limiting embodiments, the protective guard 2070 can be removed to expose components of the wiper system 2000. The protective guard 2070, when used, can be formed of one or more pieces, and the material used to form the protective guard is generally a durable material (e.g., metal, durable plastic, composite material, etc.).

Still referring to FIGS. 6-7, the wiper system 2000 functions similarly to that of the wiper system 200 as illustrated in FIGS. 1-5, the difference being that the wiper system 2000 includes one or more spring systems 2050a, 2050b (or similar biasing system) instead of counterweights. In the present non-limiting embodiment, the wiper system 2000 comprises: (i) a brush or scraper 2010 configured to remove unwanted material from the endless belt 1010 traveling along the bottom track 1030 of the conveyor 1000 and/or to clean the one or more belt cleats 1050; (ii) optional deflection bumpers 2030a, 2030b; (iii) optional adjustable plate mechanisms 2040a, 2040b; (iv) one or more optional spring systems 2050a, 2050b each comprising one or more springs 2052a, 2052b (or similar biasing elements) coupled to a coupling arrangement that optionally includes one or more optional adjustable hooks 2054a, 2054b and one or more optional rotating hooks 2056a, 2056b.

In the present non-limiting embodiment illustrated in FIGS. 6-7, a shaft 2060 supports one or more of the first wiper, brush and/or scraper 2010, the optional deflection bumpers 2030a, 2030b, the optional adjustable plate mechanisms 2040a, 2040b, the optional one or more spring systems 2050a, 2050b, and the optional one or more of the second wiper, brush and/or scraper 2020. The shaft 2060 can optionally runs along a portion or all of the inside length of the chute 3000. As can be appreciated, a motorized arrangement and/or some other arrangement be used with or instead of the weights or springs to move the one or more of the first and/or second wiper, brush and/or scraper 2010, 2020 and/or one or more other brushes related to the conveyor belt.

It is to be appreciated that the optional one or more adjustable hooks 2054a, 2054b, when used, and the optional one or more rotating hooks 2056a, 2056b, when used, could be any load-supporting component (e.g., bracket, ring, etc.) configured to couple the one or more springs 2052a, 2052b.

Still referring to FIGS. 6-7, as the endless conveyor belt 1010 runs from right to left on the bottom track 1030 of the conveyor 1000, the first wiper, brush and/or scraper 2010 removes some or all of the materials on the top surface of the endless conveyor belt 110. As the first and/or second wiper, brush and/or scraper 2010, 2020 wears over time (e.g. bristles of the brush become worn and flaccid over time/use, portions of the scraper become indented/worn, etc.), the adjustable plate mechanisms 2040a, 2040b can be adjusted via apertures 2042a, 2042b to move the first and/or second wiper, brush and/or scraper 2010, 2020 towards or away from the endless belt 1010. It is to be appreciated that the adjustable plate mechanisms 2040a, 2040b can also be adjusted to maximize the brushes/scrapers engagement with belt and provide a desired performance result. As can be appreciated, the worn first wiper, brush and/or scraper and/or the second wiper, brush and/or scraper can be replaced as required.

Still referring to FIGS. 6-7, the deflection bumpers 2030a, 2030b, when used, are configured to reduce wear on the first wiper, brush and/or scraper 2010 (e.g., bristles) by absorbing the force of the one or more belt cleats 1050 as they pass the wiper system 2000. When the optional one or more belt cleats 1050 engage the deflection bumpers 2030a, 2030b, the wiper system 2000 temporarily rotates, slides or otherwise moves along the shaft 2060. During rotation, sliding or other movement, the one or more springs 2052a, 2052b (that are coupled to the one or more adjustable hooks 2054a, 2054b and the one or more rotating hooks 2056a, 2056b) stretch to allow the one or more belt cleats 1050 to pass by/through the first wiper, brush and/or scraper 2010 with a reduced force. When the one or more belt cleats 1050 pass by/through the first wiper, brush and/or scraper 2010, the one or more springs 2052a, 2052b retract to force the first wiper, brush and/or scraper 2010 back into engagement with the conveyor belt 1010. It is to be appreciated that the wiper system 2000 can also include, in some non-limiting embodiments, a second wiper, brush and/or scraper 2020 configured to clean the one or more belt cleats 1050. Such operation of the optional second wiper, brush and/or scraper 2020 can be the same or similar as the operation of the second wiper, brush and/or scraper illustrated in FIGS. 1-5 and as described above.

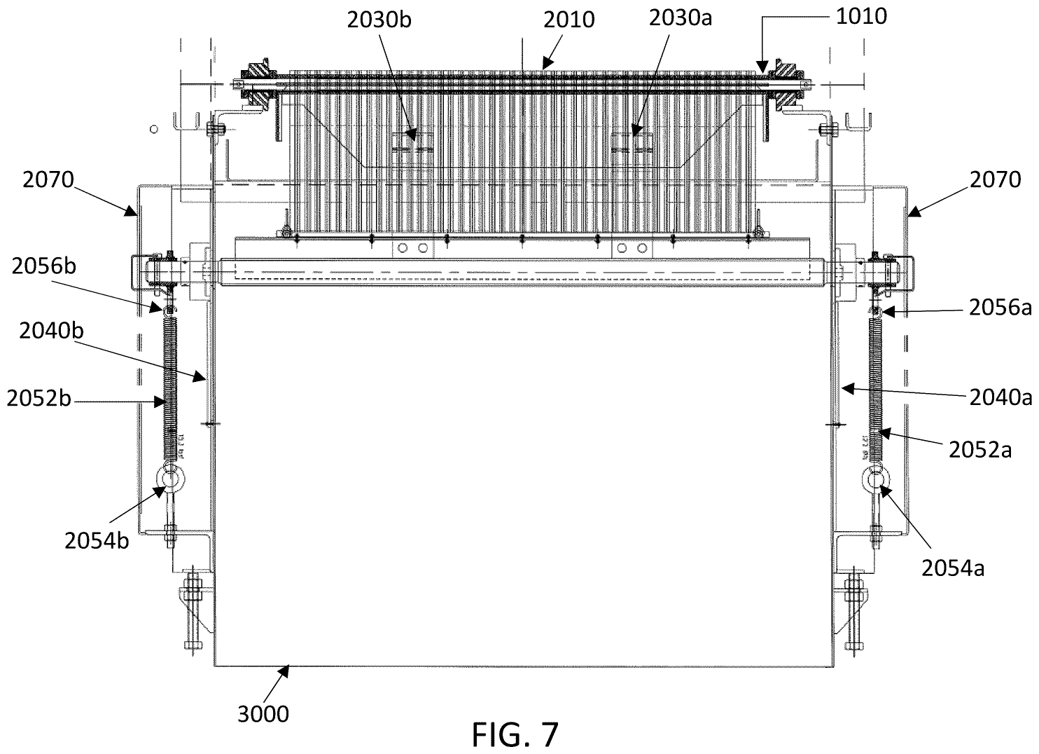

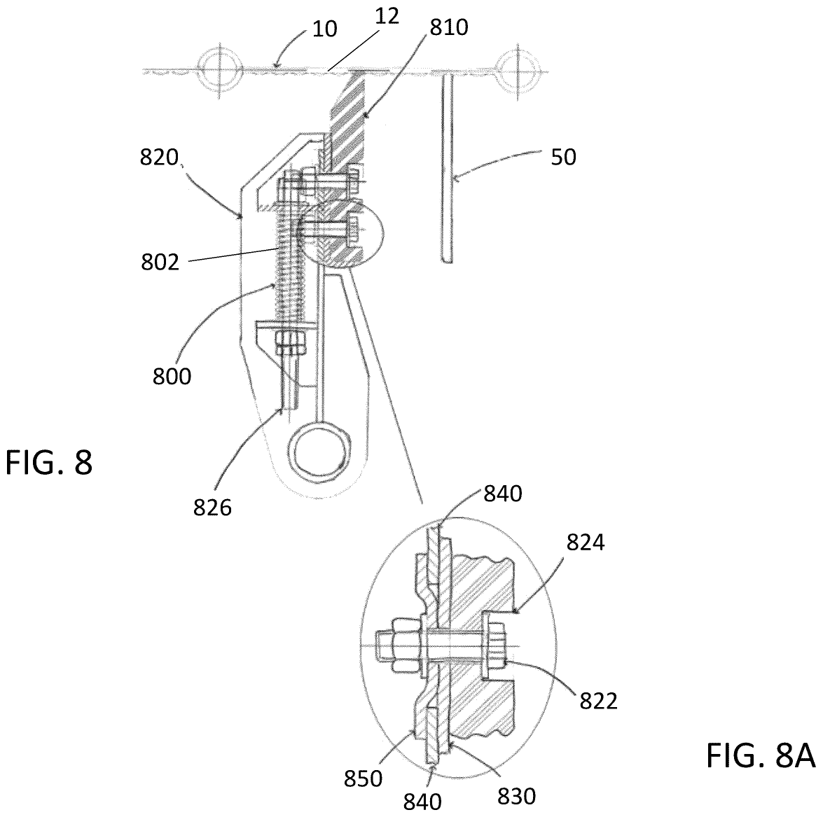

FIG. 8 provides a side view of another non-limiting, exemplary solid (anti-jamming) scraper assembly 800 that can be configured for use with the wiper system 200 and/or the wiper system 2000. With reference to FIG. 8, the anti-jamming assembly 800 is further configured for use with conveyors similar to that of conveyors 100, 1000. For example, provided is a conveyor 10 having an endless conveyor belt 12 driven by a motor, wherein the endless conveyor belt 10 is continuously traveling along a bottom track 30 of the conveyor 10 from right to left. As with the conveyors 100, 1000, the conveyor 10 in the present embodiment optionally includes one or more belt cleats 50. Although not shown, it is to be appreciated that the anti-jamming assembly 800 can be configured for use with one or more chutes similar to that of chutes 300, 3000.

Still referring to FIG. 8, in another one non-limiting embodiment, a solid wiper, scraper and/or brush 810 engages the endless conveyor belt 12 to clean, dislodge and/or remove unwanted, conveying material that remains on the top surface of the conveyor belt as it moves along the bottom track 30. As the one or more belt cleats 50 engage the solid wiper, scraper and/or brush 810, the extension spring anti-jamming assembly 800 having a spring 802 is engaged (or similar biasing anti-jamming assembly), thereby allowing for cleaning of the one or more belt cleats 50 and minimizing/reducing cleat 50 contact with the solid wiper, scraper and/or brush 810 (e.g. shifting the anti-jamming assembly 800 downward). Once the one or more belt cleats 50 clear the solid wiper, scraper and/or brush 810, the counterweights 255a, 255b (see FIGS. 3-5) and/or the spring systems 2050a, 2050b (see FIGS. 6-7) cause re-engagement of the solid scraper and/or brush 810 back to the endless belt 12 for cleaning.

Now referring to FIG. 8A, in one non-limiting embodiment, the solid wiper, scraper and/or brush 810 attaches to a metal plate holder 820 by one or more low-profile bolts 822. In one non-limiting embodiment, the anti-jamming assembly 800 couples to the metal plate holder 820 by a mounting assembly 826 (the mounting assembly 826 can include, for example, brackets; fastening members such as nuts, bolts, screws, washers, etc.; shafts etc.). In one non-limiting embodiment, the one or more low-profile bolts or similar fastening members 822 are counter-bored (see reference numeral 824) into the solid scraper and/or brush 810 to secure a tooler/scraper holder 830, a solid scraper/brush body bracket 840, and a retainer slider plate 850.

It is to be appreciated that in some embodiments, the disclosed wiper systems can include springs, counterweights, or both springs and counterweights.

In some non-limiting embodiments, the disclosed conveyors, wiper systems, and/or chutes could include one or more sensors S configured to: (i) detect the presence of unwanted material on the bottom track; (ii) detect the position of the unwanted material on the bottom track; (iii) detect whether the unwanted material is received in the chute; (iv) detect the speed and/or position of the conveyor belt moving along the bottom track; (v) detect the amount of wear of the first and/or second wiper, brush and/or scraper; (vi) detect the amount of force applied by the first and/or second wiper, brush and/or scraper to the top surface of the conveyor belt; and/or (vii) detect the amount of force (e.g., weight force, biasing force, etc.) that is applied to the first and/or second wiper, brush and/or scraper.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall there between. The disclosure has been described with reference to the certain embodiments. These and other modifications of the disclosure will be obvious from the disclosure herein, whereby the foregoing descriptive matter is to be interpreted merely as illustrative of the disclosure and not as a limitation. It is intended to include all such modifications and alterations insofar as they come within the scope of the appended claims.

To aid the Patent Office and any readers of this application and any resulting patent in interpreting the claims appended hereto, Applicant does not intend any of the appended claims or claim elements to invoke 35 U.S.C. 112(f) unless the words “means for” or “step for” are explicitly used in the particular claim.

What is claimed:

1. A conveyor belt system that removes and/or dislodges material from a conveyor belt; said conveyor belt system includes said conveyor belt; an upper conveyor belt run; a lower conveyor belt run; a belt return device; a top track and a bottom track that said conveyor belt runs on; a belt drive that causes movement of said conveyor belt about said belt return device; and a wiper system that is configured to remove at least a portion of the material that remains on a top surface of said conveyor belt while said conveyor belt moves on said bottom track; and wherein said conveyor belt travels on said top track in a first direction toward said belt return device; and wherein said conveyor belt travels on said bottom track in a second direction after said conveyor belt pasts said belt return device; and wherein at least a portion of said wiper system engages and/or is positioned closely adjacent to said top surface of said conveyor belt as said conveyor belt travels along said bottom track.

2. The conveyor belt system as defined in claim 1, wherein said conveyor belt travels on said top track in an opposite direction of said conveyor belt traveling on said bottom track; said top and bottom tracks are spaced from one another.

3. The conveyor belt system as defined in claim 1, further including a bottom chute that is configured to receive material that is dislodged or removed from said conveyor belt by said wiper system; said bottom chute is a) coupled to a portion of said conveyor belt system other than said wiper system, b) coupled to a portion of said wiper system, c) spaced from said wiper system and be positioned beneath a portion of said wiper system, and/or d) positioned partially or fully about said wiper system.

4. The conveyor belt system as defined in claim 1, wherein said wiper system includes a) one or more first wipers that are configured to engage with the material on said top surface of said conveyor belt and facilitate in removing or dislodging the material from said top surface of said conveyor belt as said conveyor belt pass said one or more wipers, b) one or more first brushes that are configured to engage with the material on said top surface of said conveyor belt and facilitate in removing or dislodging the material from said top surface of said conveyor belt as said conveyor belt pass said one or more brushes, and/or c) one or more first scrapers that are configured to engage with the material on said top surface of said conveyor belt and facilitate in removing or dislodging the material from said top surface of said conveyor belt as said conveyor belt pass said one or more scrapers.

5. The conveyor belt system as defined in claim 4, wherein said wiper system includes a) one or more second wipers, b) one or more second brushes, and/or c) one or more second scrapers; said one or more second wipers, second brushes, and/or second scrapers are spaced from said one or more first wipers, first brushes, and/or first scrapers.

6. The conveyor belt system as defined in claim 4, wherein said wiper system includes a support structure that extends over 50-100% a width of said conveyor belt; said support structure is configured to partially or fully support one or more of said one or more first wipers, one or more of said first brushes and/or one or more of said first scrapers.

7. The conveyor belt system as defined in claim 5, wherein said wiper system includes a support structure that extends over 50-100% a width of said conveyor belt; said support structure is configured to partially or fully support one or more of said first and/or second wipers, one or more of said first and/or second brushes and/or one or more of said first and/or second scrapers.

8. The conveyor belt system as defined in claim 4, wherein said wiper system includes one or more counterweights and/or one or more spring-loaded systems that are configured to cause said one or more first wipers, said one or more first brushes, and/or said one or more first scrapers to move into engagement with the material on one or portions of said conveyor belt.

9. The conveyor belt system as defined in claim 5, wherein said wiper system includes one or more counterweights and/or one or more spring-loaded systems that are configured to cause said one or more of said first and/or second wipers, one or more of said first and/or second brushes and/or one or more of said first and/or second scrapers to move into engagement with the material on one or portions of said conveyor belt.

10. The conveyor belt system as defined in claim 8, wherein said one or more counterweights and/or one or more spring-loaded systems are adjustable to adjust an amount of force is applied to said one or more first wipers, said one or more first brushes, and/or said one or more first scrapers when causing said one or more first wipers, said one or more first brushes, and/or said one or more first scrapers to engage one or portions of said conveyor belt.

11. The conveyor belt system as defined in claim 9, wherein said one or more counterweights and/or one or more spring-loaded systems are adjustable to adjust an amount of force is applied to said one or more of said first and/or second wipers, one or more of said first and/or second brushes and/or one or more of said first and/or second scrapers when causing said one or more of said first and/or second wipers, one or more of said first and/or second brushes and/or one or more of said first and/or second scrapers to engage one or portions of said conveyor belt.

12. The conveyor belt system as defined in claim 4, wherein said wiper system includes one or more adjustable plate mechanisms that are configured to adjust a portion of said one or more first wipers, said one or more first brushes, and/or said one or more first scrapers towards and/or away from said conveyor belt so as to (i) reduce wear on said one or more first wipers, said one or more first brushes, and/or said one or more first scrapers; (ii) obtain a desired spacing from or engagement with said conveyor belt by said one or more first wipers, said one or more first brushes, and/or said one or more first scrapers; and/or (iii) provide desired performance results of dislodging or removing material from said top surface of said conveyor belt as said conveyor belt pass said one or more first wipers, said one or more first brushes, and/or said one or more first scrapers.

13. The conveyor belt system as defined in claim 1, wherein said wiper system includes one or more belt-thumpers and/or vibration arrangements that are configured to provide a “knocking” and/or vibration to said conveyor belt to assist in removing or disengaging the material from said top surface of said conveyor belt as said conveyor belt passes said wiper system.

14. The conveyor belt system as defined in claim 1, wherein said wiper system includes one or more anti-jamming assemblies that are configured to a) partially or fully clean one or more belt cleats on said conveyor belt as said conveyor belt pass said wiper system, and/or b) minimize or reduce contact with one or more belt cleats on said conveyor belt by said one or more first wipers, said one or more first brushes, and/or said one or more first scrapers so as to reduce wear on said one or more wipers, brushes and/or scrapers as said one or more belt cleats on said conveyor belt on said conveyor belt pass said wiper system.

15. The conveyor belt system as defined in claim 1, wherein said wiper system includes one or more sensors that are configured to (i) detect a presence of the material on said conveyor belt as said conveyor belt moves along said bottom track; (ii) detect a position of the material on said conveyor belt as said conveyor belt moves along said bottom track; (iii) detect whether the material is received in a chute after being dislodged or removed from said top surface of said conveyor belt by at least a portion of said wiper system; (iv) detect a speed and/or position of one or more portions of said conveyor belt as said conveyor belt moves along said bottom track; (v) detect an amount of wear of one or more first wipers, said one or more first brushes, and/or said one or more first scrapers of said wiper system; (vi) detect an amount of force applied by one or more first wipers, said one or more first brushes, and/or said one or more first scrapers of said wiper system to said top surface of said conveyor belt; and/or (vii) detect an amount of force and/or weight that is applied to a support system of one or more first wipers, said one or more first brushes, and/or said one or more first scrapers.

16. The conveyor belt system as defined in claim 1, further including a protective guard; said protective guard partially or fully surrounds said wiper system.

17. The conveyor belt system as defined in claim 1, wherein said wiper system includes one or more deflection bumpers that are reduce wear on said first wiper, said first brush and/or said first scraper by absorbing a force of one or more belt cleats as such belt cleats pass said wiper system.

18. A system for removing material from a conveyor belt comprising providing a conveyor belt system as defined in claim 1 and wherein said wiper system is configured to remove and/or dislodge the material on said conveyor belt as said conveyor belt travels on said bottom track.

19. A method for removing material from a conveyor belt comprising:
a. providing a conveyor belt system as defined in claim 1; and
b. causing at least a portion of said wiper system to engage a portion of said conveyor belt as said conveyor belt travels on said bottom track to at least partially dislodge and/or remove the material on said conveyor belt.
